(19) United States
(12) Patent Application Publication
(10) Pub. No.: US 2009/0286913 A1
(43) Pub. Date: Nov. 19, 2009

(54) PRESSURE-SENSITIVE ADHESIVE AND METHOD OF PREPARING THE SAME

(75) Inventors: Hao Fei KUO, Taoyuan County (TW); Chang Jian WENG, Chiayi City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DAXON TECHNOLOGY INC., Tao-Yuan Hsien (TW)

(21) Appl. No.: 12/342,155

(22) Filed: Dec. 23, 2008

(30) Foreign Application Priority Data
May 14, 2008 (TW) 097117663

(51) Int. Cl. C08K 5/101; C08K 3/34

(52) U.S. Cl. 524/315; 524/501; 524/442

(57) ABSTRACT

The invention discloses a pressure-sensitive adhesive (PSA) and a method of preparing the same. The method comprises steps of: a) providing oil phase resin; b) diluting hardener and additive with a solvent and then adding the diluted solution to the oil phase resin; and c) adding a solution of polyaniline with a solid content over 0.06% to the oil phase resin. Accordingly, the antistatic PSA is obtained.

### CROSS-REFERENCE TO RELATED APPLICATIONS

This non-provisional application claims priority under 35 U.S.C. §119(a) on Patent Application No. 097117663 filed in Taiwan, R.O.C. on May 14, 2008, the entire contents of which are hereby incorporated by reference.

### BACKGROUND OF THE INVENTION

1. Field of the Invention

The invention relates to a pressure-sensitive adhesive (PSA) and, more particularly, to an antistatic PSA and the method of preparing the same.

2. Description of the Prior Art

Please refer to FIG. 1. FIG. 1 is a sectional view illustrating a polarizer 1 of prior art. As shown in FIG. 1, the polarizer 1 comprises a release film 10, a pressure-sensitive adhesive (PSA) layer 12, a polyvinyl alcohol (PVA) basis layer 16, two triacetyl cellulose (TAC) supporting films 14 and 18, and protecting film 20. Sometimes, there are some other special processes applied on the surface of the polarizer 1 in order to prevent reflection, e.g. adding an anti-glare layer or an anti-reflection layer.

In general, it may add an antistatic agent into the PSA, and then spread the finished PSA to form an antistatic film. However, there are a lot of materials that can serve as antistatic material in the antistatic agent, e.g. nano-Au, nano-Ag, amine, conductive macromolecule, etc. There are several conventional techniques are shown as follows:

1) U.S. Pat. No. 5,993,694:
U.S. Pat. No. 5,993,694 disclosed an antistatic agent compound, which is a water-soluble polyaniline mixed with a sulfonic acid. However, the water-soluble polyaniline can only be applied in a water-soluble or water-dispersible acrylic acid polymer, and not in a water-insoluble acrylic resin or oil-soluble resin.

2) U.S. Pat. No. 7,169,333:
U.S. Pat. No. 7,169,333 disclosed an antistatic agent comprising a perfluoroalkyl sulfonate. The antistatic agent here comprises fluoride, and it has a poor transparency after adding a thermoplastic resin.

3) U.S. Pat. No. 7,144,634
U.S. Pat. No. 7,144,634 disclosed a transparent conductive film made of polylactic acid. The conductive film here comprises a multilayer structure, wherein a conductive material only exists on the top layer, and not the entire film. At the same time, it must contain 2% by weight to have obvious impedance. As a result, neither the antistatic nor the optical behavior is good.

4) U.S. Pat. No. 7,067,571
U.S. Pat. No. 7,067,571 disclosed an antistatic agent formed by a borate ester of polyoxyalklene. The synthesis of the antistatic agent has high complexity, while the impedance of the antistatic agent can only reach 10¹¹˜10¹². Besides, the antistatic agent has a bad compatibility with the PSA, such that the antistatic agent can not be an additive to the PSA.

5) U.S. Pat. No. 5,914,186
U.S. Pat. No. 5,914,186 disclosed a heat-resistant antistatic PSA tape comprising an electrolyte base polymer, a salt of alkali metals, a salt of alkaline earth metals and a thermal-stabilizing amine. The heat-resistant antistatic agent is ionic and capable of surviving over 200° C. However, the impedance of the PSA reveals under wet condition. It shows no antistatic behavior under dry condition.

The invention discloses an antistatic PSA and method of preparing the same, so as to solve the aforesaid problems.

### SUMMARY OF THE INVENTION

A scope of the invention is to provide a pressure-sensitive adhesive (PSA). A plurality of polyaniline macromolecules, which have a conjugated system, is distributed over the PSA applied on a polarizer. After maturation, an antistatic film is produced. According to an embodiment, the PSA of the invention comprises an oil phase resin, a hardener, an additive, a solvent, and a solution of polyaniline, wherein a solid content of the solution of polyaniline is over 0.06%.

Another scope of the invention is to provide a method of preparing a PSA. The method comprises steps of: a) providing an oil phase resin; b) diluting a hardener and an additive with a solvent and then adding the diluted solution to the oil phase resin; and c) adding a solution of polyaniline with a solid content over 0.06% to the oil phase resin.

Accordingly, the invention discloses an antistatic and dust-proofing film, which is formed by heat-solidifying a PSA with conductive polyaniline macromolecules distributed over it.

The advantage and spirit of the invention may be understood by the following recitations together with the appended drawings.

### BRIEF DESCRIPTION OF THE APPENDED DRAWINGS

FIG. 1 is a sectional view illustrating a polarizer of prior art.

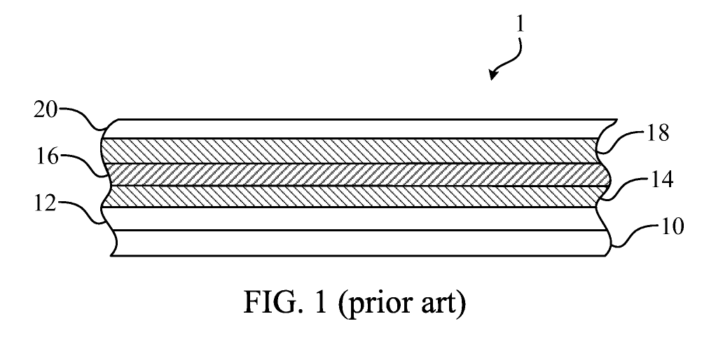

FIG. 2 is a flow chart illustrating a method of preparing the PSA according to an embodiment of the invention.

FIG. 3 is a flow chart illustrating the method of preparing the solution of polyaniline according to an embodiment of the invention.

### DETAILED DESCRIPTION OF THE INVENTION

A pressure-sensitive adhesive (PSA) is an adhesive which is capable of achieving a high-quality bond within a short time when a slight pressure is applied to the adhesive. The PSA can flow over a surface like liquid, and it can also be anti-stripping like solid. The PSA is often classified into rubber, acrylic or silicone group by its composition. The PSA can be also classified into solvent, emulsion or hot-melt based on its manufacturing. A PSA of the invention belongs to the solvent-based acrylic adhesives. The PSA of the invention, with high chemical and weather tolerance, can be widely used in practical applications.

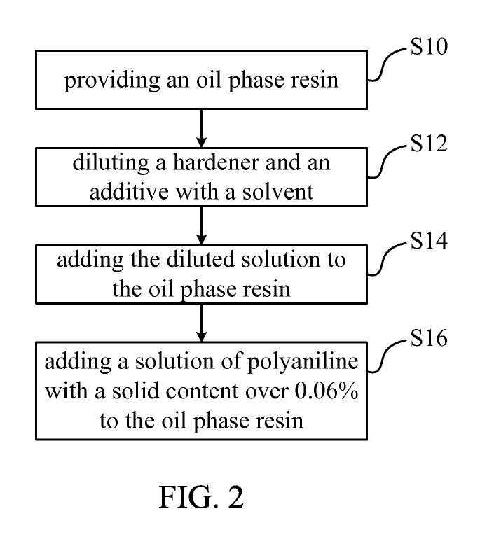

Please refer to FIG. 2. FIG. 2 is a flow chart illustrating a method of preparing the PSA according to an embodiment of the invention. First, step S10 is performed to provide an oil phase resin, which can be an acrylic resin or an epoxy resin. Afterward, step S12 is performed to dilute a hardener and an additive with a solvent, wherein the hardener can be an isocyanate, the additive can be a silane, and the solvent can be an ethyl acetate, but not limited to the three. Step S14 is then performed to add the diluted solution to the oil phase resin. Finally, step S16 is performed to add a solution of polyaniline with a solid content over 0.06% to the oil phase resin. Accordingly, the PSA with antistatic effect is obtained.

The PSA is to be spread onto a polarizer, and the PSA is then heat-solidified to form an antistatic and dust-proofing film.

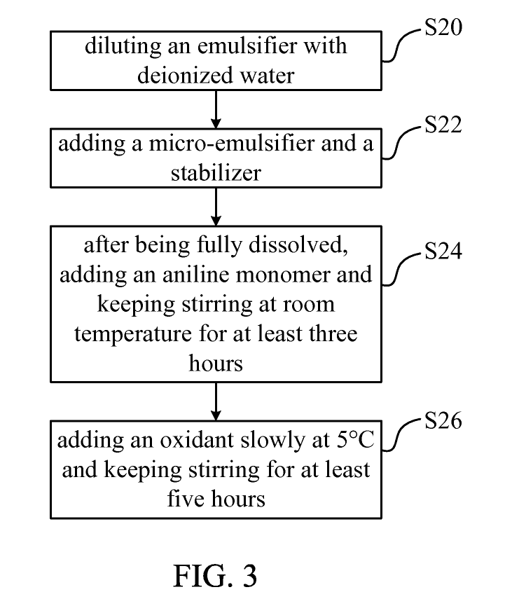

The solution of polyaniline of the invention is essentially consisted of an emulsifier, deionized water, a micro-emulsifier, a stabilizer, an aniline monomer and an oxidant. Please refer to FIG. 3. FIG. 3 is a flow chart illustrating the method of preparing the solution of polyaniline according to an embodiment of the invention. First, step S20 is performed to dilute an emulsifier with deionized water. The emulsifier can be, but not limited to, a dodecylbenzene sulfonic acid (DBSA). Afterward, step S22 is performed to add a micro-emulsifier and a stabilizer into the solution. The micro-emulsifier can be a 1-pentanol, and the stabilizer can be, but not limited to, a polyethylene glycol (PEG). After the micro-emulsifier and the stabilizer are fully dissolved, step S24 is performed to add an aniline monomer into the solution, and keep stirring at room temperature for at least three hours. Finally, step S26 is performed to add an oxidant slowly at 5° C. and keeping stirring for at least five hours. The oxidant can be, but not limited to, an ammonium persulfate (APS). Accordingly, the solution of polyaniline of the invention is obtained.

Preferably, the ratio of the aniline monomer to the oxidant is between 4:1 and 3:1.

In practical application, the solution of polyaniline with electrical conductivity can be prepared as follows. Dilute 3 grams of the DBSA (the emulsifier) into 500 ml of the deionized water. Add 0.1 gram of the 1-pentanol (the micro-emulsifier) and 2 grams of the PEG (the stabilizer). After all the above are fully dissolved, add 0.6 gram of the aniline monomer and keep stirring at room temperature for twelve hours. The solution will gradually turn into milk white color. Add 0.2 gram of APS (oxidant) into the milk white solution slowly and keep stirring for five hours under a condition of ice-bathing. By then, it obtains the solution of polyaniline with a solid content around 1.3%. The solution is dark green-colored and electric-active.

The following are four experimental instances for further demonstration.

Experimental Instance 1:

In the experimental instance 1, a product is formed by adding 0.06 gram of the solution of polyaniline into 99.94 grams of the PSA prepared in advance. The product has to be stirred and spread over an upper release film of the polarizer. Measure an impedance of the product after its maturation. The impedance of the product is shown in following Table 1.

Experimental Instance 2:

In the experimental instance 2, a product is formed by adding 0.09 gram of the solution of polyaniline into 99.91 grams of the PSA prepared in advance. The product has to be stirred and spread over the upper release film of the polarizer. Measure an impedance of the product after its maturation. The impedance of the product is shown in following Table 1.

Experimental Instance 3:

In the experimental instance 3, a product is formed by adding 0.13 gram of the solution of polyaniline into 99.87 grams of the PSA prepared in advance. The product has to be stirred and spread over the upper release film of the polarizer. Measure an impedance of the product after its maturation. The impedance of the product is shown in following Table 1.

Experimental Instance 4:

In the experimental instance 4, a product is formed by adding 0.21 gram of the solution of polyaniline into 99.79 grams of the PSA prepared in advance. The product has to be stirred and spread over the upper release film of the polarizer. Measure an impedance of the product after its maturation. The impedance of the product is shown in following Table 1.

Compared Instance:

In the compared instance, a product is formed by spreading a conventional PSA over the upper release film of the polarizer. Measure an impedance of the product after its maturation. The impedance of the product is shown in following Table 1.

TABLE 1

| | Content of PSA | Content of polyaniline | |
|---|---|---|---|
| | (Wt. %) | (Wt. %) | impedance |
| Instance 1 | 99.94% | 0.06% | 4.43 × 10¹² |
| Instance 2 | 99.91% | 0.09% | 2.09 × 10¹² |
| Instance 3 | 99.87% | 0.13% | 3.19 × 10¹² |
| Instance 4 | 99.79% | 0.21% | 1.19 × 10¹² |
| Comparison | 100% | — | over 10¹⁴ |

It should be noticed that the experimental and compared instances are demonstrating under a testing condition and by a testing mean.

Testing condition: a total thickness of the PSA is about 25 mm.

Testing mean: testing a surface resistivity with a Resistivity Meter 1824 (BJZ) under an operating voltage at 100 volts.

As shown in Table 1, adding a solution of polyaniline with a solid content over 0.06% to the PSA may effectively reduce the impedance to 10¹² order.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A pressure-sensitive adhesive comprising:
an oil phase resin;
a hardener;
an additive;
a solvent; and
a solution of polyaniline with a solid content over 0.06%.

2. The pressure-sensitive adhesive of claim 1, wherein the oil phase resin is an acrylic resin or an epoxy resin.

3. The pressure-sensitive adhesive of claim 1, wherein the hardener is an isocyanate.

4. The pressure-sensitive adhesive of claim 1, wherein the additive is a silane.

5. The pressure-sensitive adhesive of claim 1, wherein the solvent is an ethyl acetate.

6. The pressure-sensitive adhesive of claim 1, wherein the solution of polyaniline is essentially consisted of an emulsifier, deionized water, a micro-emulsifier, a stabilizer, an aniline monomer and an oxidant.

7. The pressure-sensitive adhesive of claim 6, wherein a ratio of the aniline monomer to the oxidant is between 4:1 and 3:1.

8. The pressure-sensitive adhesive of claim 6, wherein the emulsifier is a dodecylbenzene sulfonic acid (DBSA).

9. The pressure-sensitive adhesive of claim 6, wherein the micro-emulsifier is a 1-pentanol.

10. The pressure-sensitive adhesive of claim 6, wherein the stabilizer is a polyethylene glycol (PEG).

11. The pressure-sensitive adhesive of claim 6, wherein the oxidant is an ammonium persulfate (APS).

12. The pressure-sensitive adhesive of claim 1, the pressure-sensitive adhesive being applied in manufacturing a polarizer.

13. A method of manufacturing a pressure-sensitive adhesive, comprising steps of: providing an oil phase resin;
diluting a hardener and an additive with a solvent and then adding the diluted solution to the oil phase resin; and
adding a solution of polyaniline with a solid content over 0.06% to the oil phase resin.

14. The method of claim 13, wherein the oil phase resin is an acrylic resin or an epoxy resin.

15. The method of claim 13, wherein the hardener is an isocyanate.

16. The method of claim 13, wherein the additive is a silane.

17. The method of claim 13, wherein the solvent is an ethyl acetate.

18. The method of claim 13, wherein the solution of polyaniline is prepared by steps of:
diluting an emulsifier with deionized water;
adding a micro-emulsifier and a stabilizer;
after being fully dissolved, adding an aniline monomer and keeping stirring at room temperature for at least three hours; and
adding an oxidant slowly at 5° C. and keeping stirring for at least five hours.

19. The method claim 18, wherein a ratio of the aniline monomer to the oxidant is between 4:1 and 3:1.

20. The method of claim 18, wherein the emulsifier is a dodecylbenzene sulfonic acid (DBSA).

21. The method of claim 18, wherein the micro-emulsifier is a 1 -pentanol.

22. The method of claim 18, wherein the stabilizer is a polyethylene glycol (PEG).

23. The method of claim 18, wherein the oxidant is an ammonium persulfate (APS).
